(19) United States
(12) Patent Application Publication
(10) Pub. No.: US 2012/0036014 A1
(43) Pub. Date: Feb. 9, 2012

(54) SYSTEM FOR AND METHOD OF LOCATION AWARE MARKETING

(75) Inventor: Gururaj SUNKADA, Bangalore (IN)

(73) Assignee: Verizon Patent and Licensing, Inc., Basking Ridge, NJ (US)

(21) Appl. No.: 12/851,968

(22) Filed: Aug. 6, 2010

(51) Int. Cl. G06Q 30/00; H04W 24/00

(52) U.S. Cl. 705/14.54; 455/456.3; 705/14.58

(57) ABSTRACT

A system for and method of location aware retail may include receiving, via a network, a location of a mobile user device, generating, using at least one programmed processor, one or more search results based at least in part on the location of the mobile user device and price preference data and proximity preference data of a user of the mobile user device, and providing, via the network, information to the mobile user device based at least in part on the one or more search results.

### BACKGROUND INFORMATION

A user of a mobile device may wish to identify goods or services within a certain range of a current location. A user may be unaware of retailers in their current area as well as the availability of goods or services at such retailers.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a system for location aware marketing, according to a particular embodiment;

FIG. 2 is a block diagram of a module for performing location aware marketing, according to a particular embodiment;

FIG. 3 depicts a method for location aware marketing, according to a particular embodiment; and

FIG. 4 depicts a method for location aware marketing using alerts, according to a particular embodiment.

FIG. 5 depicts an interface for location aware marketing, according to a particular embodiment.

### DETAILED DESCRIPTION OF PREFERRED EMBODIMENTS

According to some embodiments, location aware marketing may include providing data to a user of a mobile device based on a current location of the mobile device and one or more preferences of a user of the mobile device. A vendor, service provider, or other entity may receive data indicating that a user with an interest in one or more specified products is within a specified range. Other information may be provide or accessed including a prior transaction history, a credit rating, one or more user preferences, and a price range.

According to one or more embodiments, the method may comprise receiving, via a network, a location of a mobile user device, generating, using at least one programmed processor, one or more search results based at least in part on the location of the mobile user device and price preference data and proximity preference data of a user of the mobile user device, and providing, via the network, information to the mobile user device based at least in part on the one or more search results.

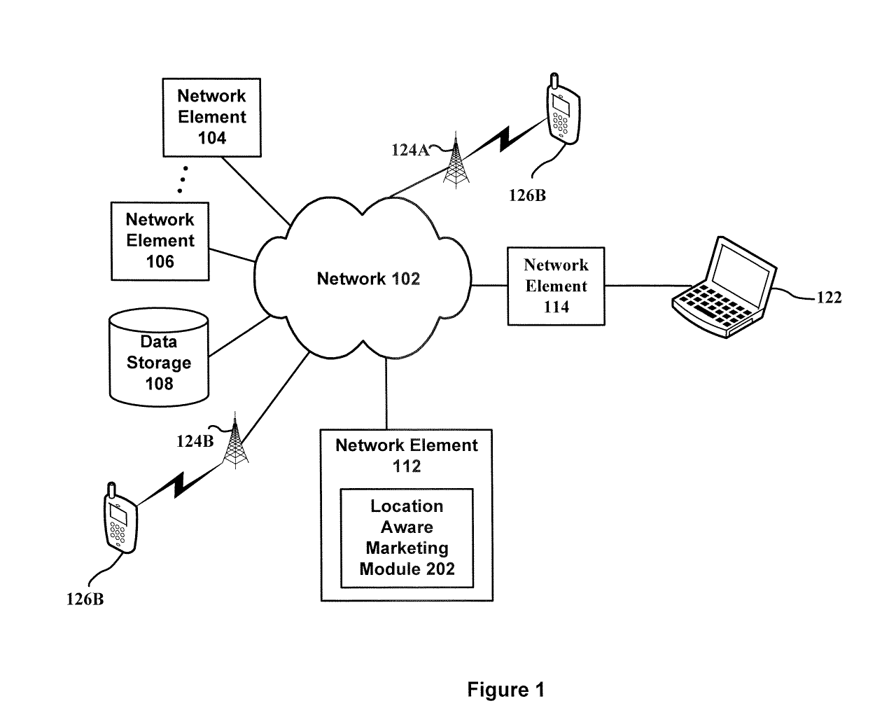

FIG. 1 is a schematic diagram illustrating a system for location aware marketing, according to a particular embodiment. As illustrated, network 102 may be communicatively coupled with one or more devices including network element 104, network element 106, data storage 108, network element 112, and network element 114. Network element 112 may contain location aware retail module 202. Other devices may communicate with network 102 via one or more intermediary devices, such as wireless devices 126A and 126B via transmitter/receivers 124A and 124 B.

The description below describes network elements, computers, and components of a system of and method for location aware marketing that may include one or more modules. As used herein, the term “module” may be understood to refer to computer implemented executable software, firmware, hardware, and various combinations thereof. Modules however are not to be interpreted as software which is not implemented on hardware, firmware, or recorded on a processor readable recordable storage medium (i.e., modules are not software per se). It is noted that the modules are exemplary. The modules may be combined, integrated, separated, and duplicated to support various applications. Also, a function described herein as being performed at a particular module may be performed at one or more other modules and by one or more other devices instead of or in addition to the function performed at the particular module. Further, the modules may be implemented across multiple devices and other components local or remote to one another. Additionally, the modules may be moved from one device and added to another device, and may be included in both devices.

Network 102 may be one or more of a wireless network, a wired network or any combination of wireless network and wired network. For example, network 102 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting and receiving a data signal. In addition, network 102 may include, without limitation, telephone line, fiber optics, IEEE Ethernet 802.3, a Wide Area Network (“WAN”), a Local Area Network (“LAN”), or a global network such as the Internet. Also, network 102 may support, an Internet network, a wireless communication network, a cellular network, or the like, or any combination thereof. Network 102 may further include one, or any number of the exemplary types of networks mentioned above operating as a stand-alone network or in cooperation with each other. Network 102 may utilize one or more protocols of one or more network elements to which it is communicatively coupled. Network 102 may translate to or from other protocols to one or more protocols of network devices. Although network 102 is depicted as a single network, it should be appreciated that according to one or more embodiments, network 102 may comprise a plurality of interconnected networks, such as, for example, a service provider network, the Internet, a broadcaster's network, a cable television network, a corporate network, and a home network.

Network elements 104, 106, 112, 114 and data storage 108 may transmit and receive data to and from network 102 such as, for example, VoIP data, videoconferencing data, multimedia data, and other data. The data may be transmitted and received utilizing a standard telecommunications protocol or a standard networking protocol. For example, one embodiment may utilize Session Initiation Protocol (“SIP”). In other embodiments, the data may be transmitted and received utilizing H.323. In yet other embodiments, data may also be transmitted and received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, or other protocols and systems suitable for transmitting and receiving broadcast or parallel search data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. Network 102 may use standard wireless protocols such as, for example, IEEE 802.11a, 802.11b 802.11g, and 802.11n. Network 102 may also use protocols for a wired connection, such as IEEE Ethernet 802.3.

According to one or more embodiments, network element 114 may be a residential gateway, such as a router, or another piece of Customer Premises Equipment (“CPE”) providing access to one or more pieces of equipment. For example, network element 114 may provide network connectivity for other clients such as network client 122. One or more additional devices may be present. For example, network element 114 may be connected to network 102 via an Optical Network Terminal (“ONT”). A gateway may also be present which may provide or deny network element 114 access to network 102.

Wireless devices 126A and 126B may communicate with network 102 via transmitter/receivers 124A and 124B. Transmitter/receivers 124 may be repeaters, microwave antennas, cellular towers, or other network access devices capable of providing connectivity between to different network mediums. Transmitter/receivers 124 may be capable of sending or receiving signals via a mobile network, a paging network, a cellular network, a satellite network or a radio network. Transmitter/receivers 124 may provide connectivity to one or more wired networks and may be capable of receiving signals on one medium such as a wired network and transmitting the received signals on a second medium such as a wireless network.

Wireless devices 126 may be a wireline phone, a cellular phone, a mobile phone, a satellite phone, a Personal Digital Assistants (PDA), a computer, a handheld MP3 player, a handheld video player, a personal media player, a gaming devices, or other devices capable of communicating with network 102 via transmitter/receivers 124. According to some embodiments, wireless devices 126 may be use Voice Over IP (“VOIP”) to provide one or more services.

Network client 122 may be a desktop computer, a laptop computer, a server, a personal digital assistant, or other computer capable of sending and receiving network signals. Network client 122 may use a wired or wireless connection. Although depicted as connected via network element 114 in FIG. 1, in one or more embodiments, network client 122 may connect directly to network 102 or via other network connectivity devices. According to one or more embodiments, network client 122 using a wireless connection may authenticate with a network using Wired Equivalent Privacy, Wi-Fi Protected Access or other wireless network security standards.

According to some embodiments, users of mobile devices (e.g., wireless devices 126 and network client 122) may download and install one or more components of a location based inventory location system onto their mobile devices. A user may activate an account, set preferences, or perform other configuration or qualification activities to carry out inventory location activities. A unique id, login, password, and other credentials may be generated or provided to a user.

Network elements 104, 106, 112, 114, and data storage 108 may include one or more processors for recording, transmitting, receiving, and storing data. Although network elements and data storage 108 are depicted as individual elements, it should be appreciated that the contents of one or more of a network element and data storage 108 may be combined into fewer or greater numbers of devices and may be connected to additional devices not depicted in FIG. 1. Furthermore, the one or more devices may be local, remote, or a combination thereof to a first network element and data storage 108.

Data storage 108 may be network accessible storage and may be local, remote, or a combination thereof to network elements 104 and 106. Data storage 108 may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, data storage 108 may be a database, such as an Oracle database, a Microsoft SQL Server database, a DB2 database, a MySQL database, a Sybase database, an object oriented database, a hierarchical database, or other database. Data storage 108 may utilize flat file structures for storage of data.

According to some embodiments, data storage 108 may be an inventory location database searchable by location, which may track stocked inventory in a specified locality with a specified retailer or retailers in general. Data storage 108 may allow location aware marketing module 202 to identify inventory using location information of a mobile user and one or more specified preferences. According to some embodiments, a service provider, a retailer, a community, or another entity may provide such a inventory location database. An inventory location database may contain retailers or other service or product providers who have been approved, registered, or entered into the database by a entity providing the inventory location database.

According to some embodiments, data storage 108 may be a relational database that may store data including, but not limited to, marketing information for one or more users, transaction information (e.g., a prior transaction by a user of a mobile device), search request data, and a previous offers to one or more users. A history of transaction information may be maintained or stored in data storage 108 to learn user consumption patterns (e.g., for different types of products, services, regions, etc.). Data storage 108 may hold and archive all browsed, searched, sale and non-sale transactions carried out. Data may be aggregated, sorted, processed, and queried to identify one or more of marketing information, business rules, or other information. According to some embodiments, data storage 108 may provide one or more APIs or other interfaces which may be used by a server or another network element to access or distribute information.

According to some embodiments, data storage 108 may contain a product portfolio of retailers, businesses, and other entities. According to some embodiments, a product portfolio may be developed by allowing retailers and businesses, and other entities, who would like to be part of a location based inventory system to be part of the location based inventory system. Retailers, businesses, and other entities participating in the location based inventory system may have unique login id and password or other access mechanisms. According to some embodiments, retailers, businesses, and other participating entities may be segmented based on region, city, county, locality, etc. Retailers, businesses, and other participating entities may dynamically keep updating their portion of ‘In Stock’ and ‘Out of Stock’ inventory data in a product portfolio.

The location based inventory system may be a platform to carry out target advertising, campaigns, promotions, and other marketing. A personal buying history may be maintained for users to browse or search through easily next time. A feedback component may allow a user to provide information about the service, suggested improvements, and user expectations to relevant retailers. Feedback may be provided via a web based user interface, SMS messages, voice mail, email, or other electronic communications. Feedback may also inform a retailer of customer proximity (e.g., a range such a distance, a town, a zip code, or a locality, but not a specific location) within a specified price range. Feedback may inform a retailer about desired products (e.g., products searched for that a retailer does not current carry or products within their category purchased within a specified proximity). Feedback may be provided on a periodic basis, an immediate basis, or both.

According to some embodiments, a location based inventory system provider (e.g., a service provider) may charge a defined percentage point on one or more transactions carried out through a location based inventory platform. According to one or more embodiments, auction programs may be carried out on the inventory platform on a revenue sharing basis (e.g., a location based inventory system provider and a retailer may share revenues from an auctioned item).

Network elements 104 and 106 may be one or more servers (or server-like devices), such as a Session Initiation Protocol (“SIP”) server. Network elements 104 and 106 may include one or more processors for recording, transmitting, receiving, and storing data. Network elements 104 and 106 may be servers of a service provider, the Internet, a broadcaster, a cable television network, or another media provider. According to some embodiments network element 104 may be a Domain Name Server (“DNS”), a gateway, or other network infrastructure. According to some embodiments, network elements 104 and 106 may be servers which may handle search and browse requests from wireless device 126, network client 122, and other network clients. Network elements 104 and 106 may provide, access, or query search data associated with products, services, and other location aware marketing data. Network elements 104 and 106 may also facilitate or handle network transactions, electronic payment, and other electronic order processing actions, according to some embodiments.

Network elements 104 and 106 may provide Application Programming Interfaces (“APIs”), interface tables, Remote Procedure Calls (“RPCs”), web services, Extensible Markup Language (“XML”) based interfaces, Simple Object Access Protocol (“SOAP”) based interfaces, Common Object Request Broker Architecture (“CORBA”) and other interfaces for sending or receiving media searches, preferences or other information.

According to one or more embodiments, network element 112 may be a server, a host, or another network element, supporting one or more clients. Network element 112 may contain location aware marketing module 202.

Location aware marketing module 202 may receive or query location data from one or more network clients (e.g., wireless device 126). Location aware marketing module 202 may receive data from a mobile device provided by a Global Positioning System (“GPS”) receiver of the mobile device. Location aware marketing module 202 may also determine or receive location information calculated using one or more of triangulation, trilateration, and multilateration. Location information may be received with other data. For example, a mobile device identifier may be received and may be used to identify stored preferences, stored searches, transaction history, credit rating, and other data associated with a user of a user device. According to some embodiments, other data may be received with location information such as, for example, user preferences, a search item, a specified price range, a specified location range, one or more product attributes, one or more service attributes, payment information, and account information.

According to some embodiments, location aware marketing module 202 may be a location based inventory locator (e.g., a shopping engine identifying a specified inventory in a specified locality) and providing inventory details (e.g., in stock and out of stock details in a particular retail store or retail stores in general). This may allow a user to further shop for the specified product or service by physically visiting an identified vendor or by shopping online.

Location aware marketing module 202 may allow a users to determine availability of specified goods in inventory, in retail outlets in a specified locality, or to search for specified goods in inventory, in a specified retail outlet in a nearby locality. According to some embodiments, location aware marketing module 202 may provide multiple results to a mobile device. This may allow a user of a mobile device to search for a specific good in inventory for a specific locality and then place an order, to shop while on move, and to shop on mobile devices, broadband connections, high speed connections, while using IPTV, tablets etc. Location aware marketing module 202 may allow comparison across retailers including criteria such as offers, discounts, distance from a user location, and other factors. A user may then place an order, reserve a product, reserve a service, or perform other actions.

Location aware marketing module 202 may allow searching by keyword, browsing by category, or other methods identifying items of interest for a user. Location aware marketing module 202 may receive location information from a mobile user device (e.g., wireless device 126A) to locate users and determine the city, place or locality they are present. According to some embodiments, wireless devices 126 may contain a Global Positioning System (“GPS”) receiver communicatively coupled to the mobile user device (e.g., integrated into wireless device 126A). According to some embodiments, location aware marketing module 202 may calculate location information or receive calculated information using one or more of triangulation, trilateration, and multilateration.

According to some embodiments, location aware marketing module 202 may be a GPS enabled application with Product Search Engine (“PSE”). Location aware marketing module 202 may crawl through a product portfolio database and fetches ‘In Stock’ and ‘Out of Stock’ inventory information for users from a particular place, locality, or retail location.

Location aware marketing module 202 may allow a user of a mobile device to perform a keyword search for a product or service. According to an exemplary embodiment, an inventory search may be carried out by searching (e.g., a keyword search) or by browsing a category. Goods that are ‘In Stock’ or ‘Out of Stock’ may be displayed to users as search results. When an inventory search is made for a product or a good by keyword, location aware marketing module 202 may pick up the request and crawl through the product portfolio and display relevant inventory results to the user. When a user desires to locate inventory by browsing (e.g., by category), location aware marketing module 202 may display a product catalogue interface to select from. Location aware marketing module 202 may pick up a request for product or service information indicated by a selection from a user and may crawl through a product portfolio and provide relevant inventory results to the user.

Search or browse results may be sorted, filtered, or otherwise processed based on pre-specified user preferences, provider preferences, and vendor preferences. For example, search results may sort available products based on price and proximity to a user. Location aware marketing module 202 may use a sorting algorithm by weighting price versus distance (e.g., x price corresponds to y distance). For example, a user may be willing to pay a dollar more for every mile closer an item is so the user may set one dollar in price to correspond to one mile in distance. A user, vendor, or a service provider may specify parameters (e.g., a maximum distance of search results to include for which vendor locations exceeding this distance from a current user location may not be included).

In addition to product or search information provided by a user during a search or browse of product offerings, a user may provide other data such as, for example, preference data. Preference data may include price preference data for a specified good, service, or category of goods or services. For example, a user may specify a range of prices or a maximum price that they may be willing to pay for a particular good (e.g., a maximum price for a particular brand and model of a watch or a menu item). A user may also provide a range for a category of goods (e.g., a maximum price for any brand or model of a watch or a maximum average price for a cuisine type). Preference data may also include shopping preferences including, but not limited to, a retailer, a distance from a current location (e.g., a maximum distance a user may be willing to travel), parking, on-line purchasing availability, and delivery. According to some embodiments, a user, a vendor, a service provider, or other entity may be able to set preferences on a sliding scale (e.g., acme widget for less than $10 and less than 10 miles away). A user may be able to weight preferences. For example, allow for sliding scale of $1 in price per 1 mile (e.g., $9 for $11 miles away or 11 for 9 miles away.) According to some embodiments, retailers may set alert preferences. For example, a retailer may set one or more thresholds to send SMS offer to consumer.

A user of a mobile device may provide preference information to location aware marketing module 202 in one or more ways. According to some embodiments, a web interface may be used. Location aware marketing module 202 may also receive an SMS message, a voicemail, or a phone call containing preference information (e.g., via speech recognition or keypad entry).

Location aware marketing module 202 may provide location based alerts to one or more users of mobile devices based upon a location of a mobile user device. For example, a location based alert may be based upon a city, county, area (e.g., zip code), a radius from a current location, or a locality alert. Location aware marketing module 202 may query a database to identify a product or service of interest to a user of the mobile user device based at least in part on one or more of a prior transaction by the user of the mobile device, a prior search by the user of the mobile device, a prior browse of online offerings by the user of the mobile device, and a prior offer to the user of the mobile device.

According to some embodiments, if a user does not find product or service locally, location aware marketing module 202 may offer to set an alert (e.g., a proximity alert). Retailers relevant to a search or browse result, which may have been out of stock or otherwise unavailable, may provide an alert to the search result requestor (e.g., a mobile user searching for a product) when the relevant product or service is available. A callback notification may be provided based upon a search result requestor's preferences, a vendor's preferences, or a combination of the two. According to some embodiments, a user may set preferences to opt in or out of such notifications and may specify parameters (e.g., price and distance parameters).

According to some embodiments, alerts, browse results, and search results may be provided to a user in one or more ways including a web interface, SMS, email, and a phone call. For example, when location aware marketing module 202 receives location information of a user, location aware marketing module 202 may generate an alert containing information about one or more available products (e.g., an SMS message about the availability of a product within a specified distance and a specified price based upon a user's prior search for that product). The alert may provide availability information, price, location, contact information, and other data (e.g., a map or directions from a current location to a relevant vendor).

According to some embodiments, location aware marketing module 202 may allow a user to order a product or service, pay for a product or service, reserve a product or service, schedule pickup for a product or service, and schedule delivery for a product or service. Location aware marketing module 202 may provide a user interface for payment accepting payment card information (e.g., credit or debit account information), account information (e.g., checking account information for an ACH transaction), online payment service information (e.g., Paypal), or other payment information (e.g., vendor account information, service provider account information). According to some embodiments, location aware marketing module 202 may receive payment information from a third party system (e.g., a vendor or bank system).

Once orders are placed and completed successfully, location aware marketing module 202 may provide automatic alerts and may update the status of orders. For example, an SMS message may be sent to a user upon inquiry by a user, at periodic intervals, when an order status changes, or based upon other triggering events.

The various components of system 100 as shown in FIG. 1 may be further duplicated, combined and integrated to support various applications and platforms. Additional elements may also be implemented in the systems described above to support various applications.

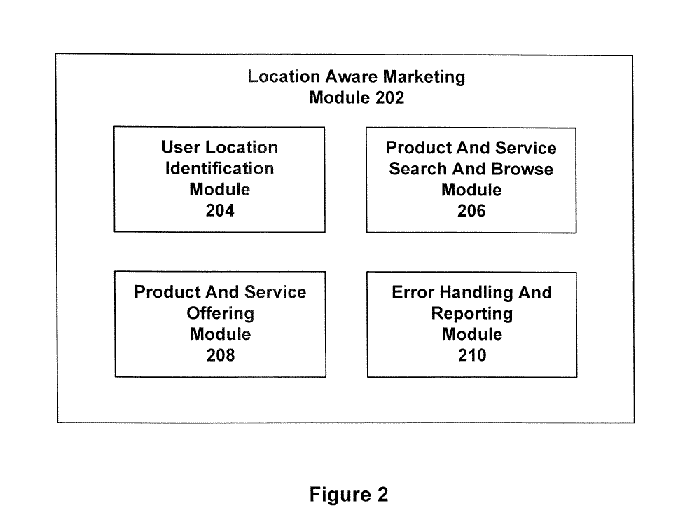

FIG. 2 is a block diagram of a hardware component of the system location aware marketing, according to a particular embodiment. As illustrated, the location aware marketing module 202 may contain one or more components including user location identification module 204, product and service search and browse module 206, product and service offering module 208, and error handling and reporting module 210. Although location aware marketing module 202 is depicted as a single module, functionality or modules of location aware marketing module 202 may be located on a single device or distributed across a plurality of devices including one or more centralized servers and one or more end user devices.

User location identification module 204 may receive or query location data from one or more network clients (e.g., wireless devices 126). User location identification module 204 may receive data from a mobile device provided by a Global Positioning System (“GPS”) receiver of the mobile device. User location identification module 204 may also determine or receive location information calculated using one or more of triangulation, trilateration, and multilateration. Location information may be received with other data. For example, a mobile device identifier may be received and may be used to identify stored preferences, stored searches, transaction history, credit rating, and other data associated with a user of a user device. According to some embodiments, other data may be received with location information such as, for example, user preferences, a search item, a specified price range, a specified location range, one or more product attributes, one or more service attributes, payment information, and account information.

Product and service search and browse module 206 may allow searching by keyword, browsing by category, or other methods identifying items of interest for a user. Product and service search and browse module 206 may allow a user of a mobile device to perform a keyword search for a product or service. According to an exemplary embodiment, an inventory search may be carried out by searching (e.g., a keyword search) or by browsing a category. Goods that are ‘In Stock’ or ‘Out of Stock’ may be displayed to users as search results. When an inventory search is made for a product or a good by keyword, product and service search and browse module 206 may pick up the request and crawl through the product portfolio and displays relevant inventory results to the user. When a user wants to locate inventory by browsing (e.g., by category), product and service search and browse module 206 may display a product catalogue to select from. Product and service search and browse module 206 may pick up a request for product or service information indicated by a selection from a user and may crawl through a product portfolio and provide relevant inventory results to product and service offering module 208.

In addition to product or search information provided by a user during a search or browse of product offerings, a user may provide other data such as, for example, preference data. Preference data may include price preference data for a specified good, service, or category of goods or services. For example, a user may specify a range of prices or a maximum price that they may be willing to pay for a particular good (e.g., a maximum price for a particular brand and model of a watch or a menu item). A user may also provide a range for a category of goods (e.g., a maximum price for any brand or model of a watch or a maximum average price for a cuisine type). Preference data may also include shopping preferences including, but not limited to, a retailer, a distance from a current location (e.g., a maximum distance a user may be willing to travel), parking, on-line purchasing availability, and delivery.

Product and service offering module 208 may organize and present search results, browse results, alerts, and other product and service offerings. Search or browse results may be sorted, filtered, or otherwise processed based on pre-specified user preferences, provider preferences, and vendor preferences. For example, search results may sort available products based on price and proximity to a user. Product and service offering module 208 may use a sorting algorithm by weighting price vs. distance (e.g., x price corresponds to y distance). A user, vendor, or a service provider may specify parameters (e.g., a maximum distance of search results to include (e.g., vendor locations exceeding this distance from a current user location may not be included).

According to some embodiments, alerts, browse results, and search results may be provided to a user in one or more ways including a web interface, SMS, email, and a phone call. For example, product and service offering module 208 may generate an alert containing information about one or more available products (e.g., an SMS message about the availability of a product within a specified distance and a specified price based upon a user's prior search for that product). The alert may provide availability information, price, location, contact information, and other data (e.g., a map or directions from a current location to a relevant vendor).

Error handling and reporting module 210 may handle one or more errors associated with location aware marketing. Error handling and reporting module 210 may provide alerts or messages to administrators in the event of an error. Error handling and reporting module 210 may produce one or more reports including diagnostic test result reports and corrective action reports. Error handling and reporting module 210 may produce log files and reports in one or more formats.

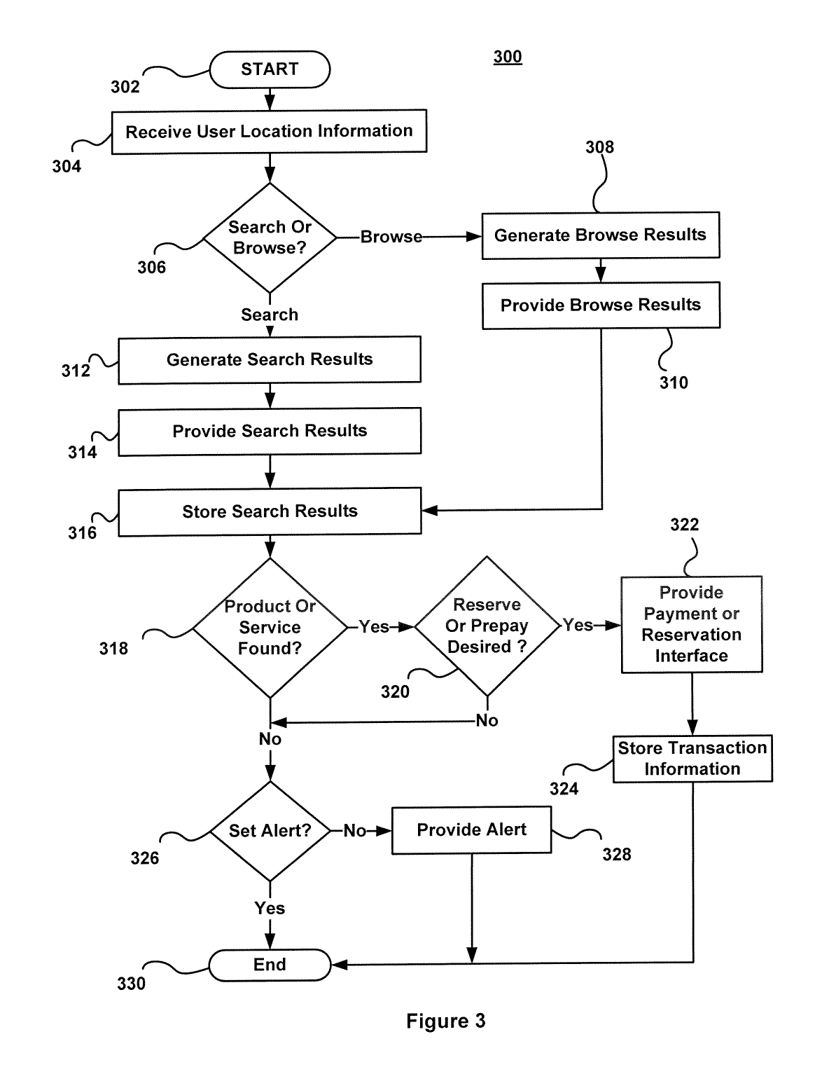

FIG. 3 depicts a method for FIG. 3 depicts a method for location aware marketing, according to a particular embodiment. At block 302, the method 300 for location aware marketing may begin.

At block 304, user location information may be received. A location aware marketing system may receive data from a mobile device provided by a Global Positioning System (“GPS”) receiver of a mobile device. A location aware marketing system may also determine or receive location information calculated using one or more of triangulation, trilateration, and multilateration. Location information may be received with other data. For example, a mobile device identifier may be received and may be used to identify stored preferences, stored searches, transaction history, credit rating, and other data associated with a user of a user device. According to some embodiments, other data may be received with location information such as, for example, user preferences, a search item, a specified price range, a specified location range, one or more product attributes, one or more service attributes, payment information, and account information.

At block 306, it may be determined whether to provide a search or browse interface to the user. If a user indicates a desire to search via a user interface (e.g., clicks on a URL of a web interface for a search) the method 300 may continue at block 312. If a user indicates a desire to browse, the method may continue at block 308.

At block 308, a user interface containing categories of goods and services may be presented to a user. The user may click on a category or otherwise indicate a selection and browse results may be generated.

At block 310, browse results may be provided to a user. For example, a user may select a category of electronics and a list of popular electronic items may be presented. A user may also be presented with a list of subcategories. According to some embodiments, browse results may be provided using a web based interface.

At block 312, a search interface may be presented to a user allowing a user to select or input search criteria. After receiving search criteria, search results may be generated using entered search criteria, user preferences, vendor preferences, and other search data.

At block 314, search results may be provided to a user. Search results may be sorted, filtered, or otherwise processed based on pre-specified user preferences, provider preferences, and vendor preferences. For example, search results may sort available products based on price and proximity to a user. A sorting algorithm may be used which may weight price vs. distance (e.g., x price corresponds to y distance). A user, vendor, or a service provider may specify parameters (e.g., a maximum distance of search results to include (e.g., vendor locations exceeding this distance from a current user location may not be included). According to some embodiments, search results may be provided to a user in one or more ways including a web interface, SMS, email, and a phone call.

At block 316, search history, search results, browse history, and browse results may be saved. A history of transaction, search, and browse information may be maintained or stored in data storage 108 to learn user consumption patterns (e.g., for different types of products, services, regions, etc.).

At block 318, the method will determine whether a desired product or service has been located. Input may be received from a user interface indicating selection of a product or service. If a desired product or service has been located the method may continue at block 320. If a desired product or service has not been located or if a desired product or service has been located but it is out of stock, the method may continue at block 326.

At block 320, the method may determine whether reservation of and prepayment for a good or service is desired. If a user indicates that they would like to purchase or reserve a good or service the method may continue at block 322. If prepayment or reservation of a product or service is not desired the method may continue at block 326.

At block 322, a user interface for payment and reservation of goods and services may be provided. For example, a web interface may be provided to a mobile user allowing them to reserve a product or service or to pay for a product or service. According to some embodiments, a user may also schedule pickup for a product or service and schedule delivery for a product or service. The user interface for payment may accept payment card information (e.g., credit or debit account information), account information (e.g., checking account information for an ACH transaction), online payment service information (e.g., Paypal), or other payment information (e.g., vendor account information, service provider account information). According to some embodiments, payment information may be received from a third party system (e.g., a vendor or bank system).

At block 324, transaction information may be stored. Transaction information may be used for marketing purposes or other purposes. Transaction information may be stored even if a transaction is cancelled, not completed, or not approved.

At block 326, if a product or service is not found or is not in stock, a user interface may be provided allowing a user to set an alert. An alert may be provided to the user when the desired product or service is available. According to some embodiments, a user interface may not be provided and an alert may automatically be set (e.g., based on pre-specified user preferences) to notify a user when the desired product or service is available. If an alert is to be set the method may continue at block 328. If an alert is not to be set the method may end at block 330.

At block 328, an alert may be generated when the desired product or service is available. Alerts may be provided to a user in one or more ways including a web interface, SMS, email, and a phone call.

At block 330, the method 300 may end.

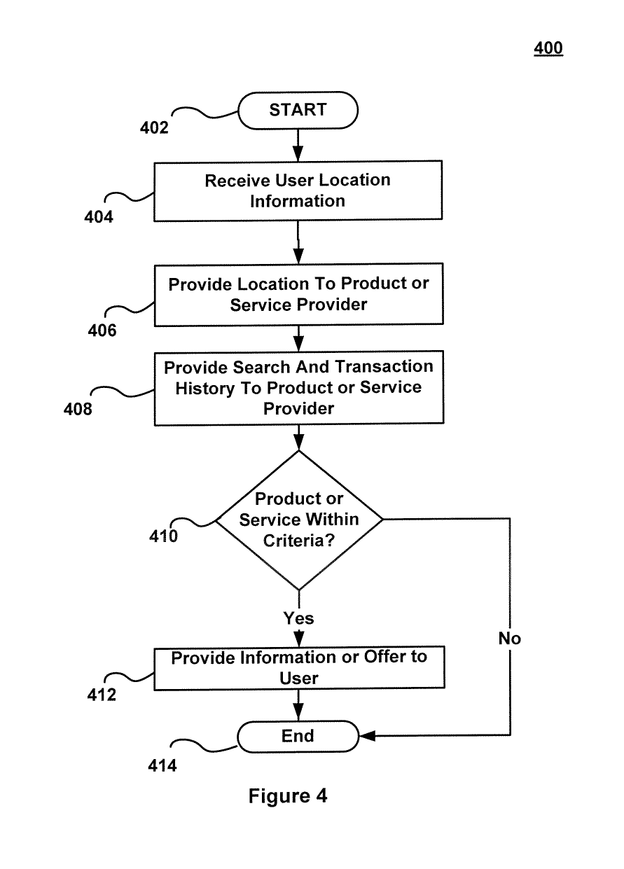

FIG. 4 depicts a method for location aware marketing using alerts, according to a particular embodiment. At block 402, the method 400 for location aware marketing using alerts may begin

At block 404, user location information may be received or queried from one or more network clients (e.g., wireless device 126). Location information may be received from a mobile device provided by a Global Positioning System (“GPS”) receiver of the mobile device. Location information may also be determine or calculated using one or more of triangulation, trilateration, and multilateration. According to some embodiments, a user may be prompted to enter or select a location. Other data may also be received from a user device, including identification data and preference data. For example, a mobile device identifier may be received and may be used to identify stored preferences, stored searches, transaction history, credit rating, and other data associated with a user of a user device. According to some embodiments, other data may be received with location information such as, for example, user preferences, a search item, a specified price range, a specified location range, one or more product attributes, one or more service attributes, payment information, and account information.

At block 406, location data and other marketing data may be provided to one or more vendors. For example, location data, user preferences, a search item, a specified price range, a specified location range, one or more product attributes, and one or more service attributes may be provided to a vendor. Location information may include, but is not limited to, a range such a distance, a town, a zip code, or a locality. According to some embodiments, location information may not include a specific location to protect privacy information of a user. An amount of information provided to a vendor may be configurable by vendor, by type, and by level of detail. A user, a service provider, or another entity may specify a level of information provided to one or more vendors.

At block 408, search history, transaction history, and other marketing information associated with a user or a mobile device may be provided to one or more vendors.

At block 410, one or more criteria may be evaluated against provided data to determine whether an available product or service meets one or more criteria. Criteria may include a product or service meeting the search criteria (e.g., product type, product name, brand, color, size, and price.) Criteria may also include, but is not limited to, a distance from a current location (e.g., a distance a user is from a vendor location) and availability. According to some embodiments, a user, a vendor, a service provider, or other entity may be able to set preferences on a sliding scale (e.g., acme widget for less than $10 and less than 10 miles away). A user may be able to weight preferences. For example, allow for sliding scale of $1 in price per 1 mile (e.g., $9 for 11 miles away or $11 for 9 miles away.) According to some embodiments, retailers may set alert preferences. If the criteria are met the method may continue at block 412. If the criteria are not met the method may end at block 414.

At block 412, information or an offer may be provided to a user of a mobile device. may be provided to a user in one or more ways including a web interface, SMS, email, and a phone call. For example, an alert may be generated containing information about one or more available products (e.g., an SMS message about the availability of a product within a specified distance and a specified price based upon a user's prior search for that product). The alert may provide availability information, price, location, contact information, and other data (e.g., a map or directions from a current location to a relevant vendor). Alert may also include coupons, sale information, and other marketing offers.

The method may end at block 414.

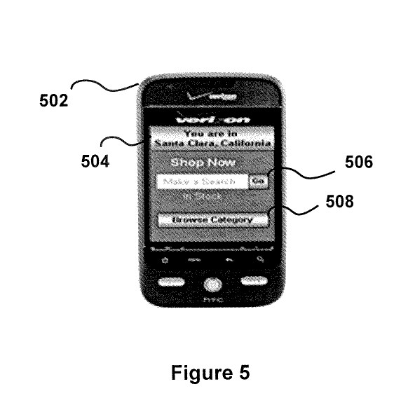

FIG. 5 depicts an interface for location aware marketing, according to a particular embodiment. As illustrated in FIG. 5, mobile user device 502 may provide a user interface for product or service location. Display element 504 may provide a current location of a user. According to some embodiments, a user may configure a level of granularity of location information provided. For example, a user may indicate that location information is to be provided in a range such a distance, a town, a zip code, or a locality. Location information displayed in display element 504 may be provided to a service provider and to one or more vendors. Display element 506 may accept user input to initiate a search (e.g., a text entry box and a button may be provided.) Display element 508 may accept user input to initiate browsing of available products and services. According to some embodiments, display element 508 may be a button providing access to a user interface organized by product and service category within the specified location of display element 504

It is further noted that the software described herein may be tangibly embodied in one or more physical media, such as, but not limited to, a compact disc (“CD”), a digital versatile disc (“DVD”), a floppy disk, a hard drive, read only memory (“ROM”), random access memory (“RAM”), as well as other physical media capable of storing software, or combinations thereof. Moreover, the figures illustrate various components (e.g., servers, computers, etc.) separately. The functions described as being performed at various components may be performed at other components, and the various components may be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A computer-implemented method, comprising:
receiving, via a network, a location of a mobile user device;
generating, using at least one programmed processor, one or more search results based at least in part on the location of the mobile user device, price preference data, and proximity preference data of a user of the mobile user device; and
providing, via the network, marketing information to the mobile user device based at least in part on the one or more search results.

2. The method of claim 1, wherein the location is provided by a Global Positioning System (GPS) receiver communicatively coupled to the mobile user device.

3. The method of claim 1, wherein the location is calculated using at least one of:
triangulation, trilateration, and multilateration.

4. The method of claim 1, further comprising:
receiving, via the network, price preference data from the mobile user device.

5. The method of claim 1, further comprising:
receiving, via the network, proximity preference data from the mobile user device.

6. The method of claim 1, wherein the proximity preference data comprises a specified maximum range from the location of the mobile user device.

7. The method of claim 1, wherein the proximity preference data comprises at least one of: a zip code, a city, and a county.

8. The method of claim 1, wherein the one or more search results are provided ordered by a lowest price and shortest distance from the location.

9. The method of claim 1, further comprising:
receiving, from the mobile user device, an indicator of interest in at least one of: a good and a service.

10. The method of claim 1, further comprising:
querying a database to identify a good of interest to a user of the mobile user device based at least in part on one or more of: a prior transaction by the user of the mobile device, a prior search by the user of the mobile device, a prior browse of online offerings by the user of the mobile device, and a prior offer to the user of the mobile device.

11. The method of claim 1, wherein generating, using at least one programmed processor, one or more search results comprises:
providing an electronic notification to a vendor of a received user device notification; and
receiving one or more of: a product offering based at least in part on the location of the mobile user device and price preference data and proximity preference data of a user of the mobile user device and a service offering based at least in part on the location of the mobile user device and price preference data and proximity preference data of a user of the mobile user device.

12. The method of claim 1, wherein marketing information to the mobile user device based at least in part on the one or more search results is provided via at least one of: SMS, email, and a phone call.

13. The method of claim 1, further comprising:
receiving payment data associated with the user of the mobile user device, the payment data based at least in part on the marketing information provided to the mobile user device; and
processing payment for at least one of: a good offered to the user of the mobile user device and a service offered to the user of the mobile user device.

14. The method of claim 13, wherein receiving payment data and processing payment data comprising receiving payment confirmation from at least one of: a vendor, a third party payment processor, and a bank.

15. The method of claim 1, wherein the marketing information provided to the mobile user device comprises at least one of: a product description, a service description, a vendor location, a map indicating a plurality of vendor locations relative to a current position of the mobile user device, a price, an in-stock indicator, payment information, reservation information, and delivery information.

16. A non-transitory computer readable storage medium comprising code to perform the acts of the method of claim 1.

17. A system, comprising:
a network element, wherein the network element comprises one or more processors configured to:
receive, via a network, a location of a mobile user device;
generate, using at least one programmed processor, one or more search results based at least in part on the location of the mobile user device, price preference data, and proximity preference data of a user of the mobile user device; and
provide, via the network, marketing information to the mobile user device based at least in part on the one or more search results.

18. A system, comprising:
a mobile user device communicatively coupled to a network;
a non-transitory location aware retail module of the mobile user device including executable instructions stored in electronic memory, wherein the location aware retail module is configured to:
provide, via a network, a location of a mobile user device;
receive one or more search results based at least in part on the location of the mobile user device, price preference data, and proximity preference data of a user of the mobile user device; and
accept input, via a user interface of the mobile user device, indicating a response to the one or more received search results.

19. The system of claim 18, wherein the proximity preference data comprises a specified maximum range from the location of the mobile user device.

20. The system of claim 18, wherein the one or more search results are provided ordered by a lowest price and shortest distance from the location.

21. The system of claim 18, wherein the response to the one or more search results comprises at least one of: initiating a purchase; putting a hold on an item; reserving a timeslot; requesting further information about a good; and requesting further information about a service.
